(19) United States
(12) Patent Application Publication
(10) Pub. No.: US 2018/0071791 A1
(43) Pub. Date: Mar. 15, 2018

(54) WATER CLEANING SYSTEMS

(71) Applicant: UNGER MARKETING INTERNATIONAL, LLC, BRIDGEPORT, CT (US)

(72) Inventors: Kai Hirsch, Cologne (DE); Bryan Lee Roberts, Dormagen (DE); Leon Fehrenberg, Bochum (DE)

(73) Assignee: UNGER MARKETING INTERNATIONAL, LLC, BRIDGEPORT, CT (US)

(21) Appl. No.: 15/809,069

(22) Filed: Nov. 10, 2017

Related U.S. Application Data
(63) Continuation of application No. PCT/US2016/032554, filed on May 13, 2016.
(60) Provisional application No. 62/160,832, filed on May 13, 2015.
(60) Provisional application No. 62/254,448, filed on Nov. 12, 2015.

(51) Int. Cl. B08B 3/02; B08B 1/00; C02F 1/00

(52) U.S. Cl. CPC B08B 3/026; B08B 3/08; C02F 1/008; B08B 1/002

(57) ABSTRACT

A water cleaning system is provided that includes a water conditioner operable among a plurality of different cleaning modes selected from the group consisting of a tap water mode, a conditioned water mode, a tap water and cleaning agent dispensing mode, a conditioned water and cleaning agent dispensing mode, a pump assisted dispensing mode, and any combinations thereof.

### CROSS REFERENCE TO RELATED APPLICATIONS

This application is continuation of International Application No. PCT/US16/32554 filed on May 13, 2016, which claims the benefit of U.S. Application Ser. No. 62/160,832 filed on May 13, 2015 and claims the benefit of U.S. Application Ser. No. 62/254,448 filed on Nov. 12, 2015, the entire contents of all of which are incorporated herein by reference.

### BACKGROUND

### 1. Field of the Disclosure

The present disclosure is related to water cleaning systems. More particularly, the present disclosure is related to water cleaning systems that allow for selection among a plurality of different cleaning modes.

### 2. Description of Related Art

Water conditioners that condition incoming tap water for use in one or more cleaning tasks are known. As used herein, the term “conditioned water” shall mean water that has been filtered, deionized, demineralized, softened, exposed any other water treatment process—including the addition of one or more additives or components, and any combinations thereof.

However, it has been determined by the present disclosure that there is a need for water cleaning systems that make use of such conditioners but allow for selection among a plurality of different cleaning modes—such as but not limited to—a tap water mode, a conditioned water mode, a tap water and cleaning agent dispensing mode, a conditioned water and cleaning agent dispensing mode, a pump assisted dispensing mode, and any combinations thereof.

Accordingly, the present disclosure provides for water cleaning systems that provide enhanced utility and ease of use as compared to prior art water conditioners.

### SUMMARY

A water cleaning system is provided that includes a water conditioner. The system can be configured among a plurality of different cleaning modes—such as but not limited to—a tap water mode, a conditioned water mode, a tap water and cleaning agent dispensing mode, a conditioned water and cleaning agent dispensing mode, a pump assisted dispensing mode, and any combinations thereof.

A water cleaning system is provided that includes a water conditioner, a first flow path valve for incoming water, a cleaning agent reservoir, a cleaning agent dispenser, and a controller. The controller controlling the first flow path valve and the cleaning agent dispenser to operate among a plurality of cleaning modes. The cleaning modes including a tap water mode, a conditioned water mode, a combined tap water and cleaning agent dispensing mode, and a combined conditioned water and cleaning agent dispensing mode. The controller, when in the conditioned water mode, controls the first flow path valve so that the flow of incoming water passes through the water conditioner. The controller, when in the tap water and cleaning agent dispensing mode, controls the first flow path valve so that the flow of incoming water bypasses the water conditioner and controls the cleaning agent dispenser to supply cleaning agent from the reservoir to the water. The controller, when in the combined conditioned water and cleaning agent dispensing mode, controls the first flow path valve so that the flow of incoming water passes through the water conditioner and controls the cleaning agent dispenser to supply cleaning agent to the conditioned water.

In some embodiments either alone or together with any one or more of the aforementioned and/or after-mentioned embodiments, the water cleaning system further includes a water pump. The controller operates the water pump. The cleaning modes further includes a pump assisted dispensing mode. The controller, when in the pump assisted dispensing mode, controls the water pump to apply a pressure to an outlet flow of water.

In some embodiments either alone or together with any one or more of the aforementioned and/or after-mentioned embodiments, the water conditioner includes a plurality of water conditioners that are fluidly connected to one another in series, in parallel, and any combinations thereof.

In some embodiments either alone or together with any one or more of the aforementioned and/or after-mentioned embodiments, the plurality of water conditioners are all of a common type of conditioner, all of a different type of conditioner, and any combinations thereof.

In some embodiments either alone or together with any one or more of the aforementioned and/or after-mentioned embodiments, the water conditioner is selected from the group consisting of a filter, a deionizer, a demineralizer, a softener, an additive or component adding conditioner, and any combinations thereof.

In some embodiments either alone or together with any one or more of the aforementioned and/or after-mentioned embodiments, the water conditioner is selected from the group consisting of a particle filter, a chlorine filter, an ion remover, a UV sterilizer, and any combinations thereof.

In some embodiments either alone or together with any one or more of the aforementioned and/or after-mentioned embodiments, the water conditioner, the first flow path valve, the water pump, the cleaning agent reservoir, the cleaning agent dispenser, and the controller are secured on a movable cart.

In some embodiments either alone or together with any one or more of the aforementioned and/or after-mentioned embodiments, the water pump, and the cleaning agent dispenser are in communication with a power source.

In some embodiments either alone or together with any one or more of the aforementioned and/or after-mentioned embodiments, the power source is at least one of a battery, a power cord outlet, a fuel cell, a solar panel, a gas generator, and any combinations thereof.

In some embodiments either alone or together with any one or more of the aforementioned and/or after-mentioned embodiments, the water conditioner, the first flow path valve, the water pump, the cleaning agent reservoir, the cleaning agent dispenser, the controller, and the power source are secured on a movable cart.

In some embodiments either alone or together with any one or more of the aforementioned and/or after-mentioned embodiments, the water cleaning system further includes a control panel in communication with the controller.

In some embodiments either alone or together with any one or more of the aforementioned and/or after-mentioned embodiments, the water cleaning system further includes a wireless controller in communication with the controller.

In some embodiments either alone or together with any one or more of the aforementioned and/or after-mentioned embodiments, the wireless controller is a control fob, a software application loaded onto a user device, and combinations thereof.

In some embodiments either alone or together with any one or more of the aforementioned and/or after-mentioned embodiments, the water cleaning system further includes a pressure meter and a total dissolved solids meter in communication with the controller. The total dissolved solids meter is in fluid communication with an outlet and/or an inlet of the water conditioner.

In some embodiments either alone or together with any one or more of the aforementioned and/or after-mentioned embodiments, the water cleaning system further includes a GPS location signal in communication with the controller. The GPS location signal being generated at the controller or received by the controller from a GPS enabled user device.

In some embodiments either alone or together with any one or more of the aforementioned and/or after-mentioned embodiments, the water cleaning system further includes a distribution manifold in fluid communication with the first flow path valve and an outlet of the water conditioner. The first flow path valve is controlled by the controller to selectively place the distribution manifold in fluid communication with the flow of incoming water or the outlet flow of water.

In some embodiments either alone or together with any one or more of the aforementioned and/or after-mentioned embodiments, the water pump is in fluid communication with an outlet of the manifold.

In some embodiments either alone or together with any one or more of the aforementioned and/or after-mentioned embodiments, the cleaning agent reservoir is in fluid communication with the manifold.

In some embodiments either alone or together with any one or more of the aforementioned and/or after-mentioned embodiments, the cleaning agent dispenser is a pump or a valve.

In some embodiments either alone or together with any one or more of the aforementioned and/or after-mentioned embodiments, the manifold has an outlet in fluid communication with a second flow path valve. The second flow path valve is in communication with the controller and fluid communication with at least two outlets so that the second flow path valve controls an outgoing water direction.

In some embodiments either alone or together with any one or more of the aforementioned and/or after-mentioned embodiments, the controller is in electrical communication with a plurality of sensors to collect information regarding one or more attributes selected from the group consisting of a GPS location of the system, an elapsed time that the system was used at a particular location, a number of gallons of tap water used, a number of gallons of conditioned water used, an amount of cleaning agent used, a pressure at any point in the system, a flow rate at any point in the system, a containment level, a chlorine level, a salt level, a quality of water currently provided by the conditioner, a TDS level, a quality of tap water entering the system, and any combinations thereof.

In some embodiments either alone or together with any one or more of the aforementioned and/or after-mentioned embodiments, the controller stores and/or communicates the information regarding the one or more attributes.

The above-described and other features and advantages of the present disclosure will be appreciated and understood by those skilled in the art from the following detailed description, drawings, and appended claims.

### BRIEF DESCRIPTION OF THE DRAWINGS

The patent or application file contains at least one photograph executed in color. Copies of this patent or patent application publication with color drawing(s) will be provided by the Office upon request and payment of the necessary fee.

FIG. 1 is a schematic depiction of an exemplary embodiment of a water cleaning system according to the present disclosure in use with a water fed cleaning brush on an extension pole;

FIG. 2 is a rear perspective view of an exemplary embodiment of a water cleaning system according to the present disclosure;

FIG. 3 is a magnified perspective view of a control panel of the water cleaning system of FIG. 2;

FIG. 4 is a rear perspective view of the water cleaning system of FIG. 2;

FIG. 5 is a side perspective view of the water cleaning system of FIG. 2;

FIG. 6 is a front perspective view of the water cleaning system of FIG. 2;

FIG. 7 is a rear perspective view of the water cleaning system of FIG. 2 illustrated in use with a remote control;

FIG. 8 is a top perspective view of the water cleaning system of FIG. 2;

FIG. 9 is a rear perspective view of the water cleaning system of FIG. 2 illustrating the control cabinet in an open position;

FIG. 10 is a magnified view of the control cabinet of FIG. 9;

FIG. 11 is a schematic depiction of a piping and instrumentation diagram of the system of FIG. 2 in a tap water dispensing mode;

FIG. 12 is a schematic depiction of a piping and instrumentation diagram of the system of FIG. 2 in a tap water and cleaning agent dispensing mode;

FIG. 13 is a schematic depiction of a piping and instrumentation diagram of the system of FIG. 2 in a conditioned water dispensing mode;

FIG. 14 is a schematic depiction of a piping and instrumentation diagram of the system of FIG. 2 in a conditioned water and cleaning agent dispensing mode;

FIG. 15 is a first alternate schematic depiction of a piping and instrumentation diagram of the system of FIG. 2 that provides two separate water outlets—in a tap water dispensing mode; and

FIG. 16 is a second alternate schematic depiction of the piping and instrumentation diagram of FIG. 15—in a tap water and cleaning agent dispensing mode;

FIGS. 17-21 are alternate schematic depictions of piping and instrumentation diagrams of alternate exemplary embodiments of water cleaning systems according to the present disclosure; and

FIG. 22 is an alternate schematic depiction of a piping and instrumentation diagram of an alternate exemplary embodiment of a water cleaning system according to the present disclosure.

### DETAILED DESCRIPTION

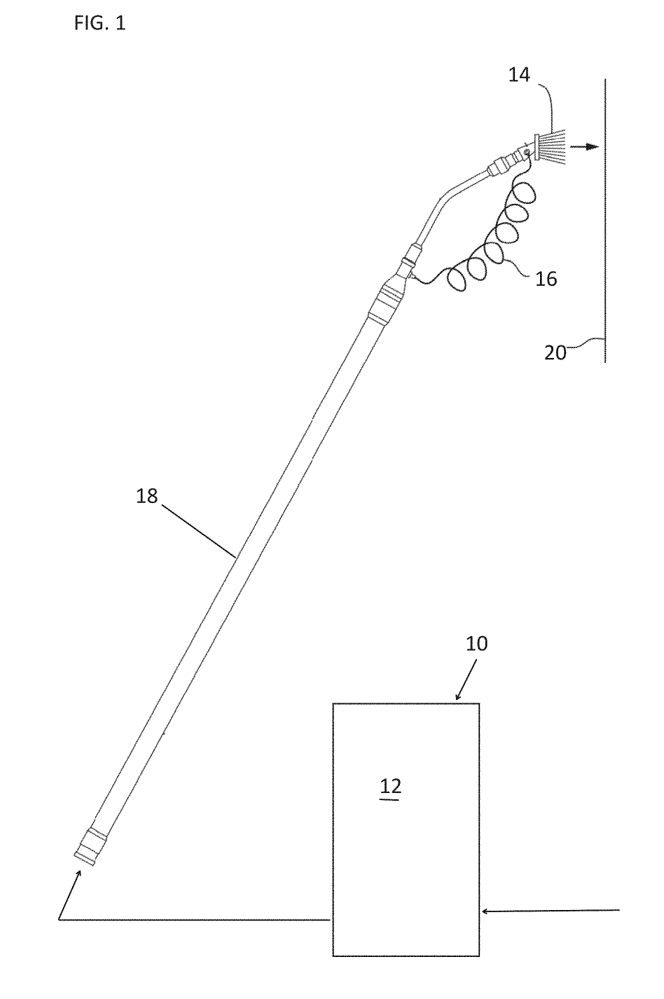

Referring to the drawings and in particular to FIG. 1, an exemplary embodiment of a water cleaning system according to the present disclosure is shown and is referred to as reference numeral 10. System 10 includes a water conditioner 12 that is shown by way of example in fluid communication with a water-fed cleaning brush 14 via one or more tubes 16 and is secured to an extension pole 18 so that the conditioned water can clean a desired surface 20.

Conditioner 12 is preferably a pure water system as shown and described in Applicant's own U.S. application Ser. No. 14/684,071 filed on Apr. 10, 2015, the contents of which are incorporated in their entirety herein.

It should be recognized that conditioner 12 is described above as a single unit. However, it is contemplated by the present disclosure for conditioner 12 to include a plurality of water conditioners that are fluidly connected to one another in series, in parallel, and any combinations thereof. The plurality of water conditioners can all be of the same type of conditioner, can be different types of conditioners, and any combinations thereof.

As discussed above, “conditioned water” means water that has been filtered, deionized, demineralized, softened, exposed any other water treatment process—including the addition of one or more additives or components, and any combinations thereof. Accordingly, conditioner 12 can include a particle filter, a chlorine filter (i.e., activated carbon), an ion remover (e.g., deionization resin and/or reverse osmosis membrane), a UV sterilizer, and any combinations thereof. When disclosing “particle filtration”, it is contemplated by the present disclosure for conditioner 12 to be sufficient for any desired filtration level such as, but not limited to, nano-filtration, ultra-filtration, micro-filtration, and others.

Advantageously, system 10 is configured to allow the flow of incoming water to be either routed through conditioner 12 or to by-pass the conditioner; to allow the flow of outgoing water to be pump assisted or to be at normal tap water pressure; to allow the flow of outgoing water to either include one or more entrained cleaning agents or to not include such agents; and any combinations thereof.

In this manner, system 10 is configurable among a plurality of different cleaning modes—such as but not limited to—a tap water dispensing mode, a conditioned water dispensing mode, a tap water and cleaning agent dispensing mode, a conditioned water and cleaning agent dispensing mode, a pump assisted dispensing mode, and any combinations thereof.

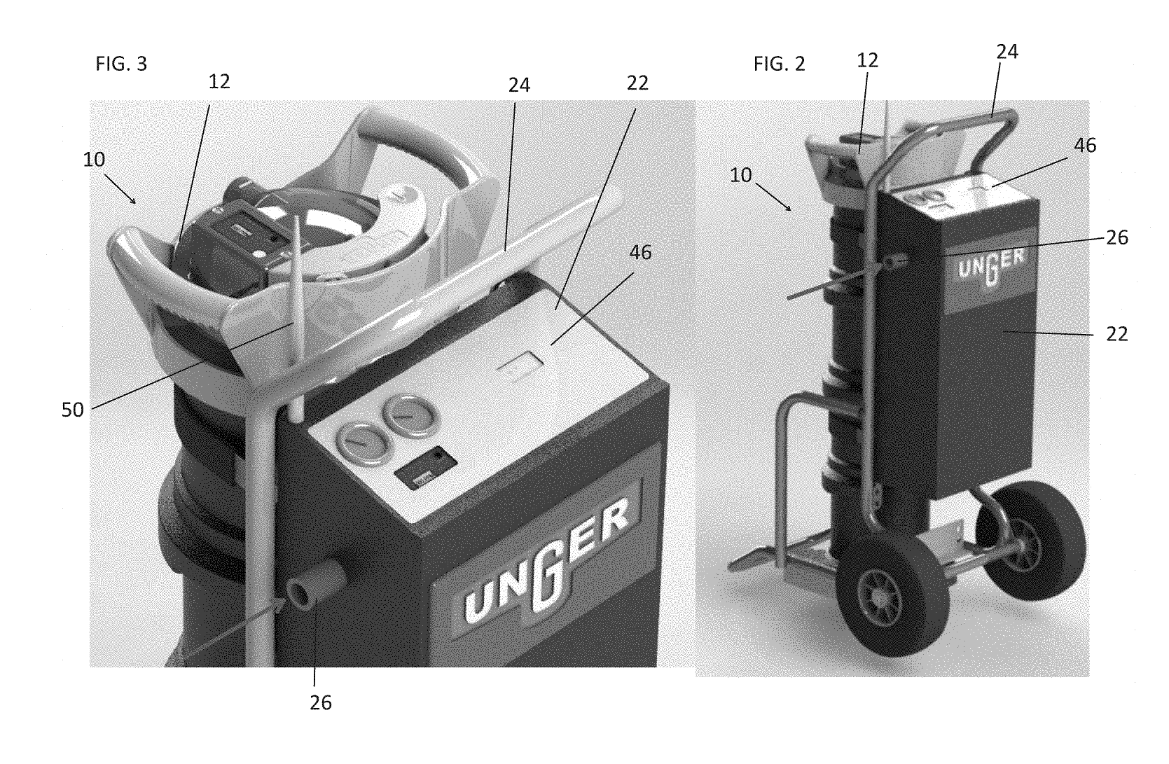

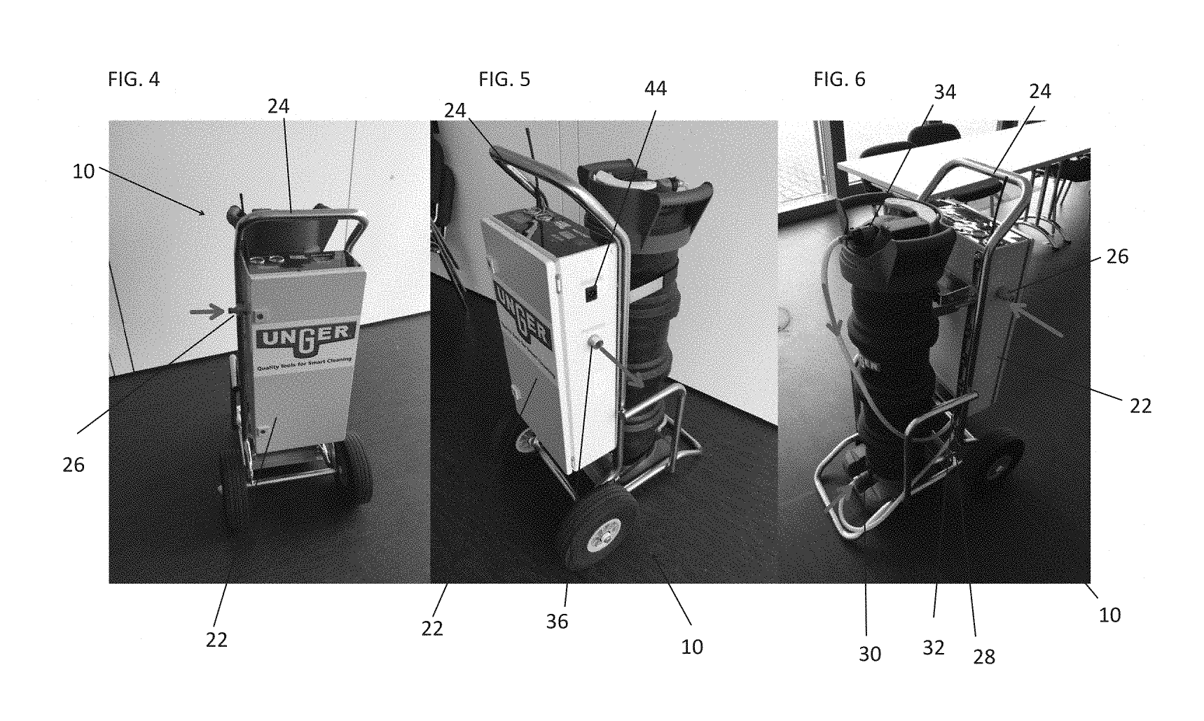

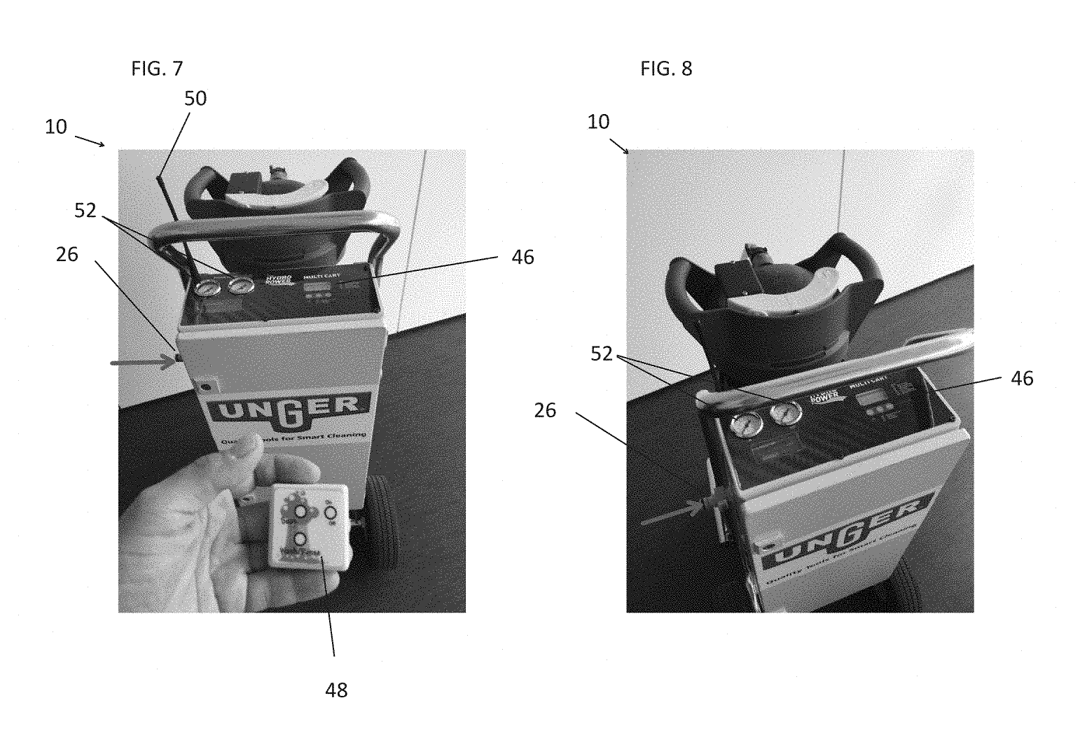

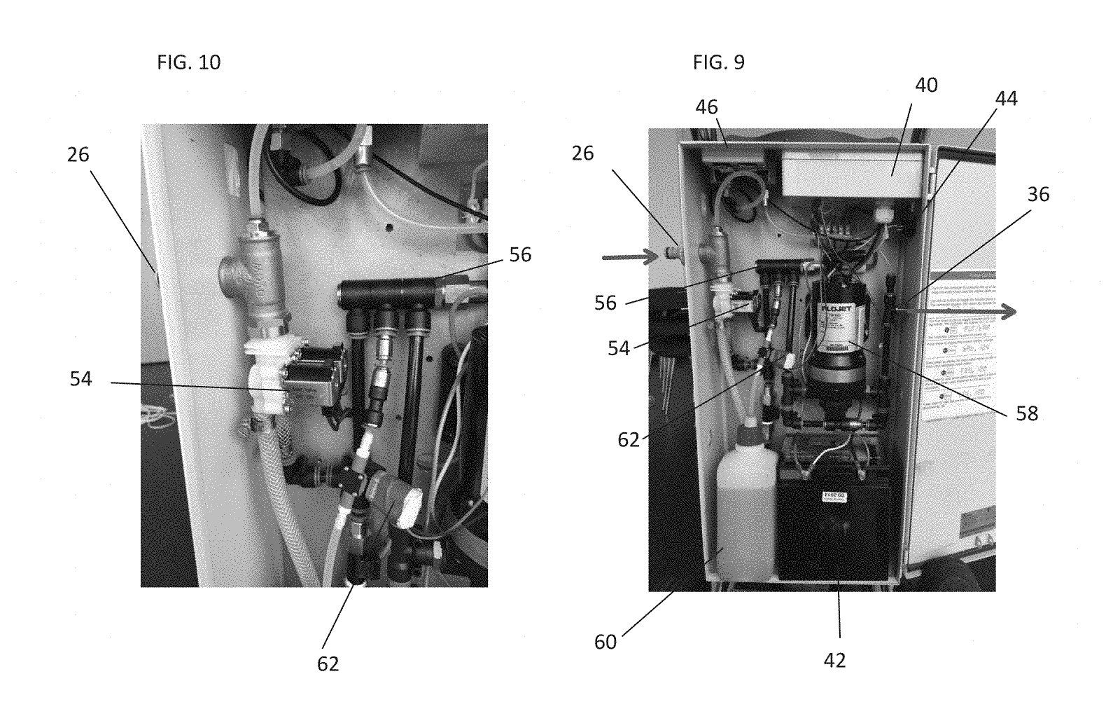

System 10 is described in more detail with simultaneous reference to FIGS. 2-10. Generally, system 10 includes conditioner 12, control cabinet 22, and, in some embodiments the conditioner and cabinet are secured on a movable cart 24. Of course, it is contemplated by the present disclosure for control cabinet 22 to a separate unit that is in electrical communication with system 10.

As will be described in more detail below, cabinet 22 includes a plurality of water inlets and a plurality of water outlets connected to one another by control valves, which allow system 10 to operate in any one of the aforementioned cleaning modes. In the figures, the flow of water is generally illustrated in red lines.

Cabinet 22 includes a tap water inlet 26 that is fluidly connectable to a source of water (e.g., a city water line), a first outlet 28 that is fluidly connectable to an inlet 30 of conditioner 12, a conditioned water inlet 32 that that is fluidly connectable to an outlet 34 of conditioner 12. Thus, cabinet 22 is configured to allow incoming tap water from inlet 26 to flow from the cabinet via outlet 28, into conditioner 12, then return the now conditioned water to the cabinet through inlet 32.

Cabinet 22 further includes a cleaning water outlet 36, which is fluidly connectable to the cleaning device—such as the water-fed cleaning brush 14 illustrated in FIG. 1.

Cabinet 22 includes a controller 40 in electrical communication with a power source 42. Power source 42 is illustrated as a battery, but it is contemplated by the present disclosure for system 10 to be connectable to any desired power source, such as, but not limited to, a power grid via a power cord outlet 44, a generator via the power cord, a battery, a fuel cell, a solar panel, a gas generator, and any combinations thereof.

Controller 40 is also in electrical communication with a control panel 46 disposed on cabinet 22. In this manner, the operator can control the operation of system 10 by inputting information into controller 40 via control panel 46.

In some embodiments, system 10 can further include a remote or wireless controller 48 in communication with controller 40. In the illustrated embodiment, system 10 further includes an antenna 50 in communication with controller 40. Antenna 50 receives—and if desired—transmits information from controller 40 to wireless controller 48. In this manner, the user can operate system 10 while remote from cabinet 22—such as when cleaning windows using brush 14 and pole 16.

Although wireless controller 48 is illustrated as a remote control or control fob, it is contemplated by the present disclosure for the wireless controller to be a software application (“app”) loadable onto a user's smart phone, laptop, tablet, and other devices. Here, system 10 can communicate information regarding one or more attributes of the system for later analysis. The attributes collectable and/or transmittable by system 10 can include attributes such as, but not limited to, a GPS location of the system, an elapsed time that the system was used at a particular location, a number of gallons of tap water used, a number of gallons of conditioned water used, an amount of cleaning agent used, a pressure and/or flow rate at any point in the system, a containment level (e.g., chlorine, salt, etc.), a quality of water currently provided by conditioner 12 (e.g., total dissolved solid or TDS level), a quality of tap water entering the system, and any other data.

Accordingly, system 10 can also include one or more sensors 52 configured to measure attributes such as, water pressure, water flow rate, temperature, total dissolved solids within the water, a level of the cleaning agent, and others. Sensors 52 can communicate the measured attributes to controller 40 and/or can communicate the attributes to the user via one or more displays present on control panel 46.

Cabinet 22 includes a first valve 54 that can be controlled by controller 40 to place inlet 26 in fluid communication with either conditioner 12 or to by-pass the conditioner. After passing through conditioner 12 or by-passing the conditioner, water is fluidly communicated to a distribution manifold 56. Thus, first valve 54 is controlled by controller 40 to selectively place manifold 56 in fluid communication with incoming tap water inlet 26 or in fluid communication with conditioned water inlet 32.

Manifold 56 is in fluid communication with a water pressure booster pump 58. System 10 is configured to controller pump 58 via controller 40 to activate the pump to increase the pressure of water exiting at outlet 36 or to leave the pump deactivated so that the water exiting via outlet 36 remains unassisted.

Manifold 56 is also in fluid communication with a cleaning agent reservoir 60. Reservoir 60 can hold a cleaning fluid such as, but not limited to, soap, detergent, bleach, an enzymatic cleaning agent, sanitizer, disinfectant, a solvent based cleaning agent, a solvent containing cleaning agent, a degreasing agent, an antimicrobial cleaning agent, an oxidizing cleaning agent, a hydrophilic coating, a hydrophobic coating, an acidic cleaning agent, an alkaline cleaning agent, a neutral cleaning agent, a nanotechnology formula/agent, and any combinations thereof.

In some embodiments, manifold 56 and reservoir 60 are configured so that the flow of water through the manifold draws, using the Venturi effect, the cleaning agent from the reservoir into the water. The amount of cleaning agent drawn from reservoir 60 can be predetermined by the configuration of system 10, or can be user adjustable via one or more flow restricting devices (not shown).

In other embodiments, system 10 can include a cleaning agent dispenser 62 configured to dispense cleaning agent from reservoir 60 into manifold 56.

In some embodiments, dispenser 62 can be a pump such that system 10 is configured to activate the pump via controller 40 to provide a desired amount of cleaning agent to the water passing through reservoir 60. The desired amount of cleaning agent that is dispensed can be predetermined by the configuration of system 10, or can be user adjustable via—for example—controller 40 and/or control panel 46. For example, controller 40 can adjust one or more attributes of pump 62 such as but not limited to pump speed, pump activation/deactivation, and others.

In other embodiments, dispenser 62 can be a valve such that system 10 is configured to open the valve via controller 40, which allows cleaning agent in reservoir 60 to be drawn into the water using in any desired method including, but not limited to, the Venturi effect.

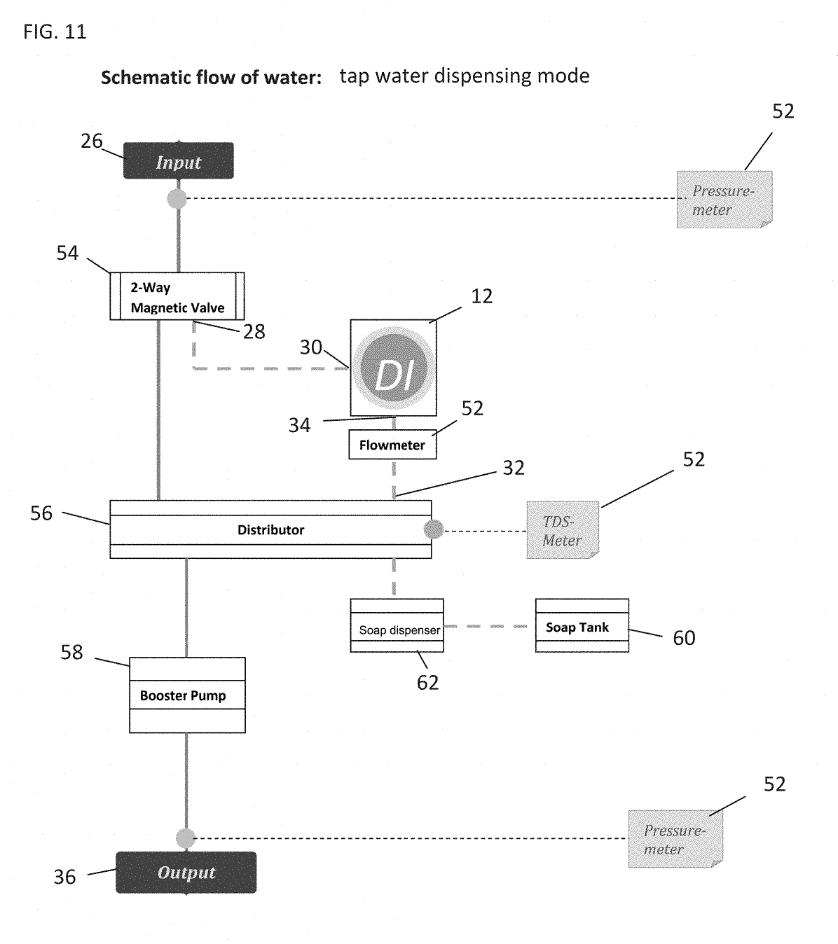

The operation and modes of system 10 is described in more detail with respect to FIGS. 11-15.

FIG. 11 is a schematic depiction of a piping and instrumentation diagram of system 10 in a tap water dispensing mode. Here, tap water input into system 10 via inlet 26 is passed through to outlet port 36 either with or without pressure boost from boost pump 58.

Specifically, during the tap water dispensing mode, system 10 is configured by controller 40 so that first valve 54 places inlet 26 in fluid communication with manifold 56. In some embodiments, system 10 can actively or passively prevent fluid communication from manifold 56 to conditioner 12 and/or reservoir 60 during the tap water dispensing mode—using for example one or more valves (not shown) controlled by controller 40, manually controlled valves (not shown), one-way valves (not shown), and any combinations thereof. In a preferred embodiment, system 10 includes a three-way solenoid valve (not shown) controlled by controller 40 to actively prevent fluid communication from manifold 56 to conditioner 12 and/or reservoir 60 during the tap water dispensing mode.

When cleaning agent dispenser 62 is present, controller 40 deactivates the pump or closes the valve so as to prevent cleaning agent from reservoir 60 from being pumped into or drawn into manifold 56. If additional pressure is desired, system 10 is configured by controller 40 so that booster pump 58 is activated.

Simply stated, when in tap water dispensing mode, system 10 is controlled to simply provide regular tap water and with or without boosted water pressure.

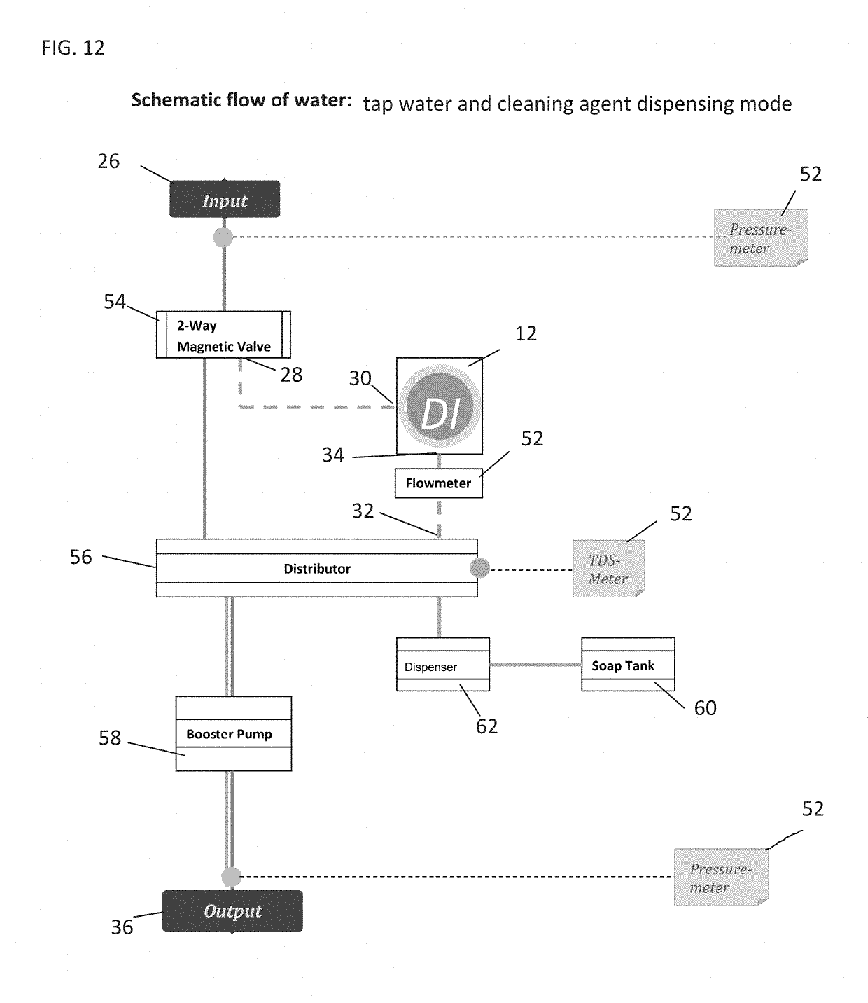

FIG. 12 is a schematic depiction of a piping and instrumentation diagram of system 10 in a tap water and cleaning agent dispensing mode.

Specifically, during the tap water and cleaning agent dispensing mode, system 10 is configured by controller 40 so that first valve 54 places inlet 26 in fluid communication with manifold 56, but prevents fluid communication from the manifold to conditioner 12. Additionally, system 10 is configured by controller 40 so that so that manifold 56 is in fluid communication with reservoir 60 so that the flow of water through the manifold draws cleaning agent from the reservoir into the water. When cleaning agent dispenser 62 is present, controller 40 activates the pump or opens the valve so as to inject cleaning agent from reservoir 60 into manifold 56. If additional pressure is desired, system 10 is configured by controller 40 so that booster pump 58 is activated.

In this manner, when in tap water and cleaning agent dispensing mode, system 10 is controlled to provide tap water having a desired concentration of cleaning agent entrained therein and with or without boosted water pressure.

System 10 is, in some embodiments, configured to allow the user to adjust the desired concentration of cleaning agent via controller 40, via any manually controlled device, and combinations thereof. Preferably, controller 40 controls dispenser 62 using a timed controlled option, which activates/deactivates the pump or opens/closes the valve to add the desired concentration of cleaning agent to the water. In other embodiments, control panel 46 includes a potentiometer (not shown) that allows the user to control dispenser 62 such as controlling the speed when the dispenser is a pump or how open the valve is when the dispenser is a valve.

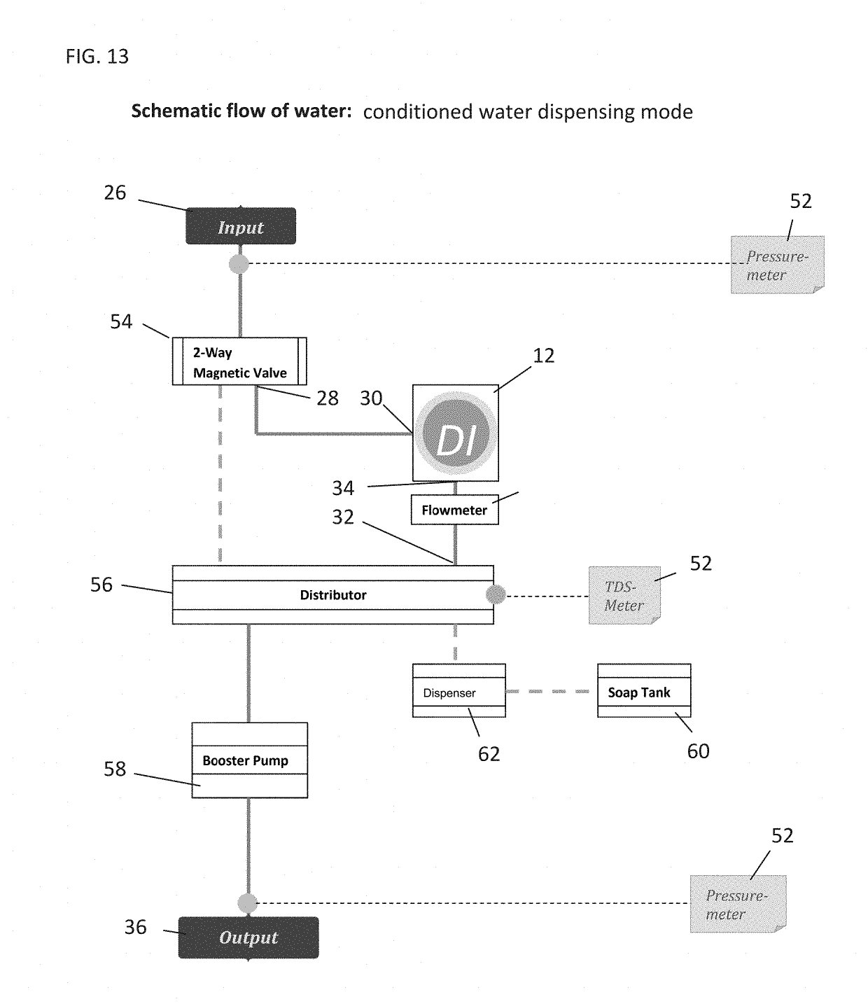

FIG. 13 is a schematic depiction of a piping and instrumentation diagram of system 10 in a conditioned water dispensing mode. During the conditioned water dispensing mode, system 10 is configured by controller 40 so that first valve 54 places inlet 26 in fluid communication with manifold 56 via conditioner 12, but prevents direct fluid communication from inlet 12 to the manifold and prevents fluid communication from the manifold to reservoir 60. When cleaning agent dispenser 62 is present, controller 40 deactivates the pump or closes the valve so as to prevent cleaning agent from reservoir 60 from being pumped/drawn into manifold 56. If additional pressure is desired, system 10 is configured by controller 40 so that booster pump 58 is activated.

In this manner, when in conditioned water dispensing mode, system 10 is controlled to provide water, as conditioned by conditioner 12, without any cleaning agent entrained therein and either with or without boosted water pressure.

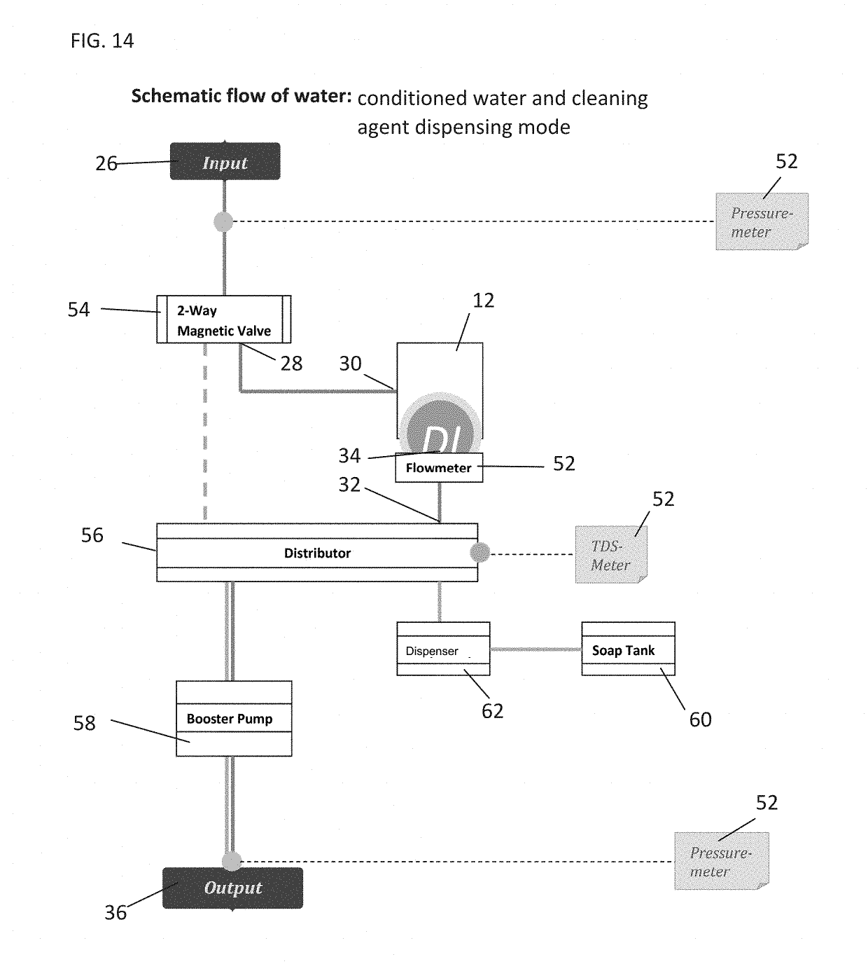

FIG. 14 is a schematic depiction of a piping and instrumentation diagram of system 10 in a conditioned water and cleaning agent dispensing mode.

During the conditioned water and cleaning agent dispensing mode, system 10 is configured by controller 40 so that first valve 54 places inlet 26 in fluid communication with manifold 56 via conditioner 12, but prevents direct fluid communication from inlet 12 to the manifold. Additionally, system 10 is configured by controller 40 so that so that manifold 56 is in fluid communication with reservoir 60 so that the flow of water through the manifold draws cleaning agent from the reservoir into the water. When cleaning agent dispenser 62 is present, controller 40 activates the pump or opens the valve so as to inject cleaning agent from reservoir 60 into manifold 56. If additional pressure is desired, system 10 is configured by controller 40 so that booster pump 58 is activated.

In this manner, when in conditioned water and cleaning agent dispensing mode, system 10 is controlled to provide water, as conditioned by conditioner 12, having a desired concentration of cleaning agent entrained therein and with or without boosted water pressure.

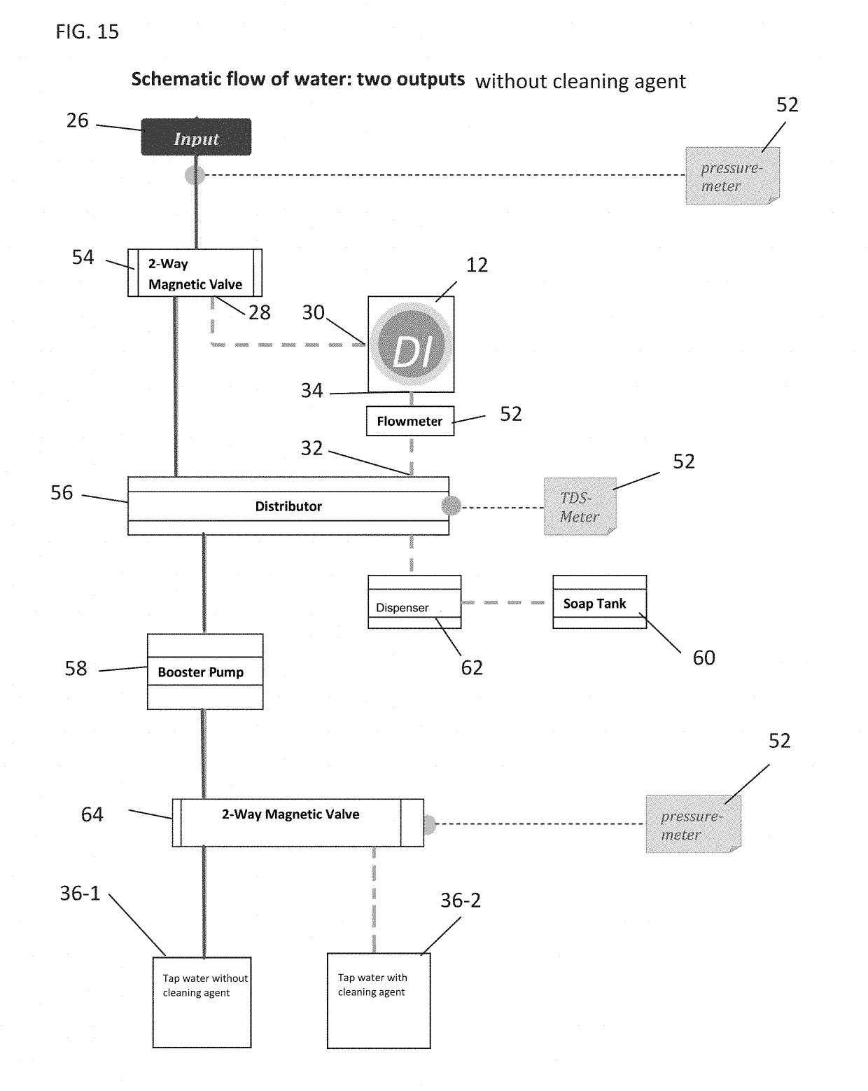

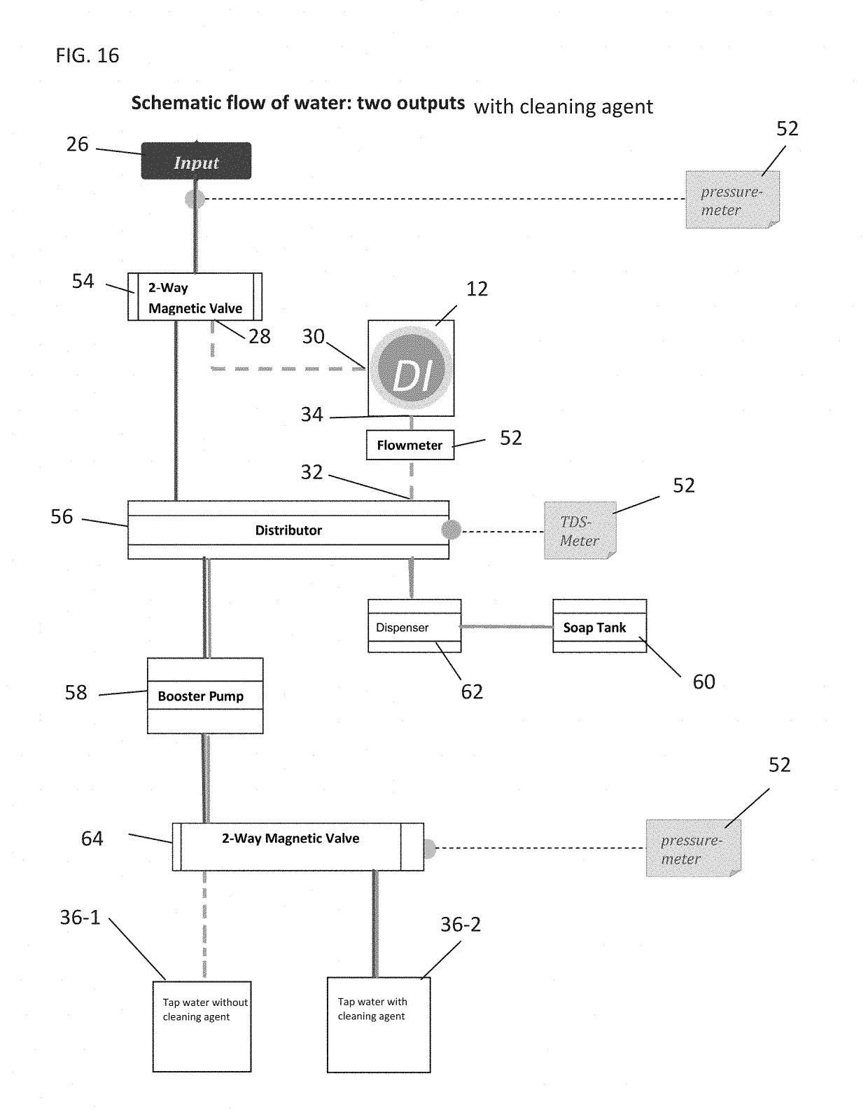

FIGS. 15 and 16 are schematic depictions of a piping and instrumentation diagram of an alternate embodiment of system 110. It has been determined by the present disclosure that when system 110 is used with cleaning agent in combination with cleaning devices, such as brush 14 that has elongated tubes 16 that are filled with the cleaning agent, there is a need to quickly transition between water with or without the cleaning agent. Namely, it can be desired for system 110 to be configured to eliminate the need to flush tubes 16 when switching back-and-forth between water with the cleaning agent and water without the cleaning agent.

Accordingly, system 110 is illustrated in FIGS. 15-16 including a second valve 64 that in controlled by controller 40 to place manifold 56 in selective fluid communication with one of two separate cleaning water outlets 36-1, 36-2. Here, system 110 can be used with cleaning devices that include two different tubes 16 (one shown in FIG. 1). The one of the tubes 16 that is intended to dispense water without cleaning agent is attached to outlet 36-1, while the tube 16 that is intended to dispense water with cleaning agent is attached to outlet 36-2.

Operation of system 110 of FIG. 15 is similar to that of system 10 described with respect to FIG. 11—but requires controller 40 to further control second valve 64 to ensure that flow of water from manifold 56 is placed in fluid communication with outlet 36-1. Conversely, operation of system 110 of FIG. 16 is similar to that of system 10 described with respect to FIG. 12—but requires controller 40 to further control second valve 64 to ensure that flow of water from manifold 56 is placed in fluid communication with outlet 36-2.

It should be recognized that system 110 of FIGS. 15-16 is shown in use with tap water. Of course, it is contemplated by the present disclosure for system 110 of FIGS. 15-16 to find equal use with conditioned water in a manner similar to that described above with respect to FIGS. 13-14, respectively.

In some embodiments, system 110 can include a sensor (not shown) at outlets 36-1 and/or 36-2 that informs controller 40 whether the system 10 is in use with a cleaning device having a single tube 16 (FIG. 1) or a device having two tubes 16. In that manner, controller 40 can automatically operate second valve 64 to place manifold 56—when system 110 is in use with a cleaning device having a single tube 16—in fluid communication with the one of outlet 36-1, 36-2 connected to the tube so that system 110 operates in a manner similar to system 10 described with respect to FIGS. 11-14.

Conversely, controller 40 can selectively operate second valve 64 to place manifold 56—when system 110 is in use with a cleaning device having two tubes 16—in fluid communication with outlets 36-1, 36-2 in a manner similar to system 110 described with respect to FIGS. 15-16.

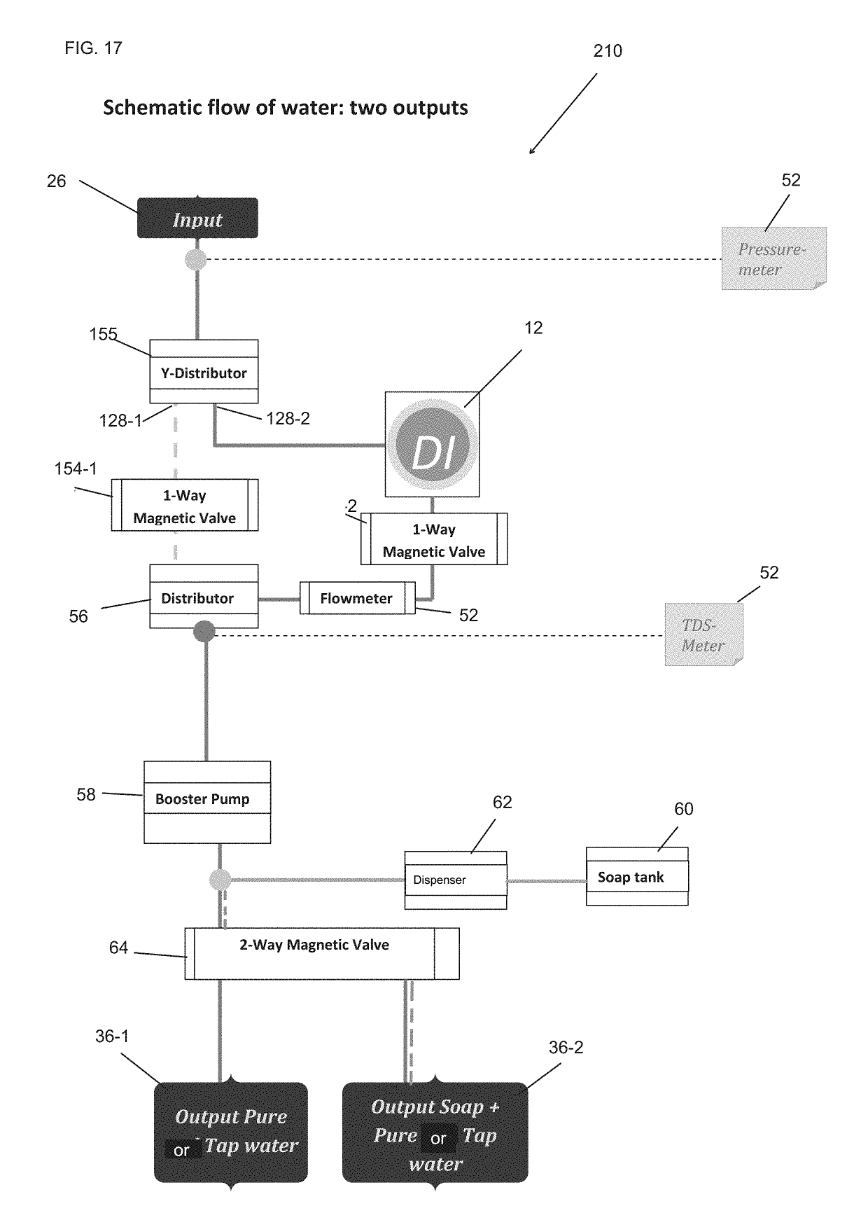

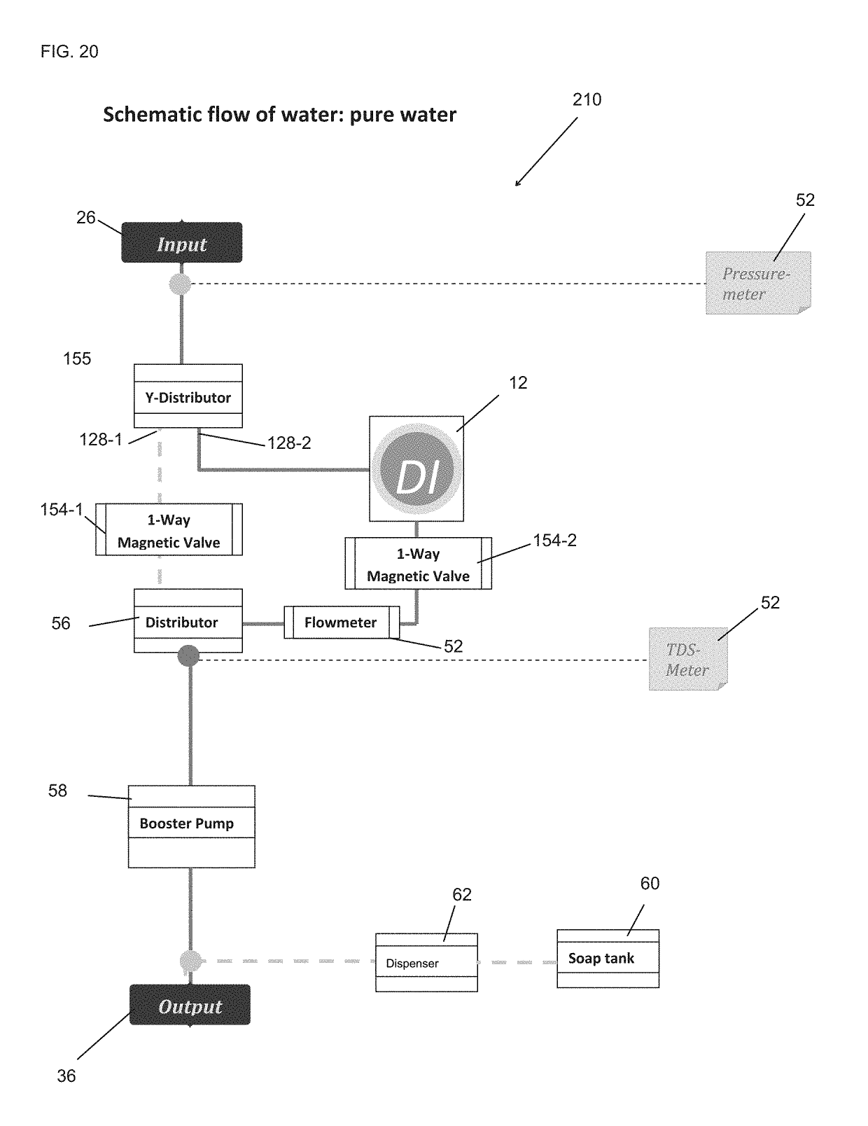

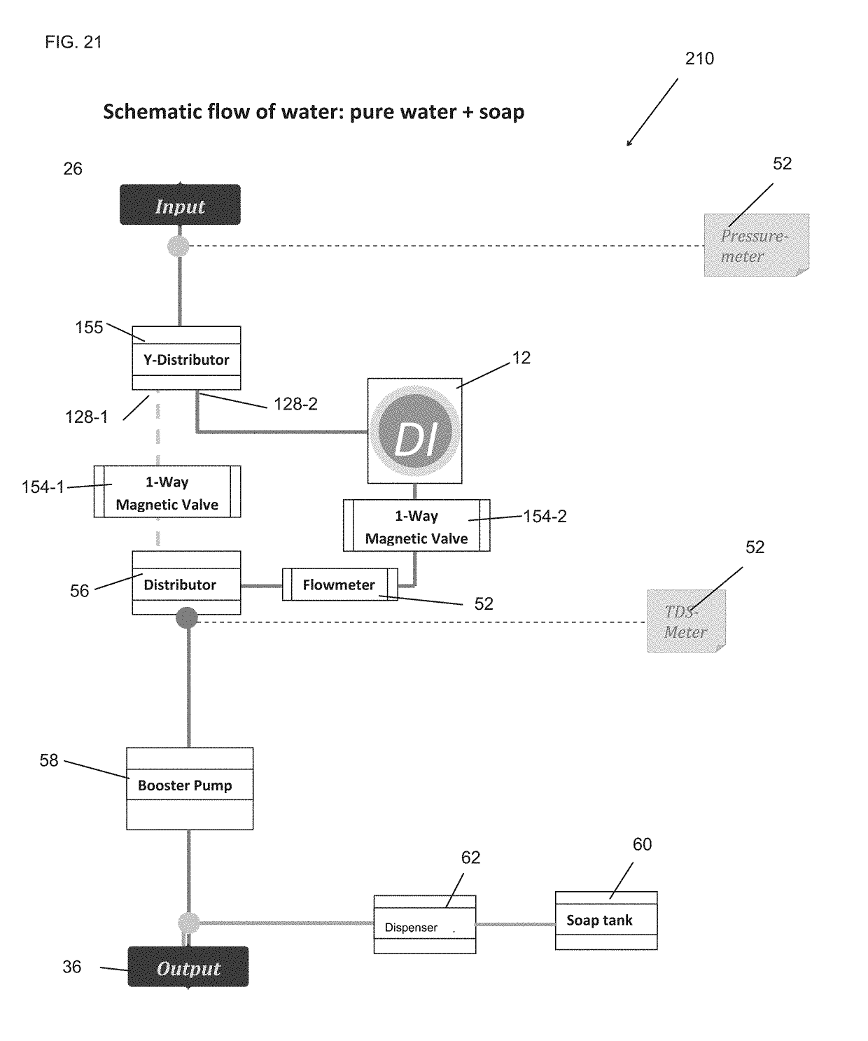

FIGS. 17-21 illustrate alternate exemplary embodiments of system 210 according to the present disclosure. In these embodiments, first valve 54, which was present shown in the earlier disclosed embodiments as a two-way valve, is replaced by a pair of one-way first valves 154-1, 154-2 and a distributor 155 having two outlets 128-1 and 128-2.

In the embodiments of FIGS. 17, 20, and 21, system 210 is shown having first valve 154-1 closed and first valve 154-2 open, which diverts the incoming water to pass through outlet 128-2 of distributor 155 and into water conditioner 12 and, thus, provide pure or conditioned water to the outlets 36-1 or 36-2.

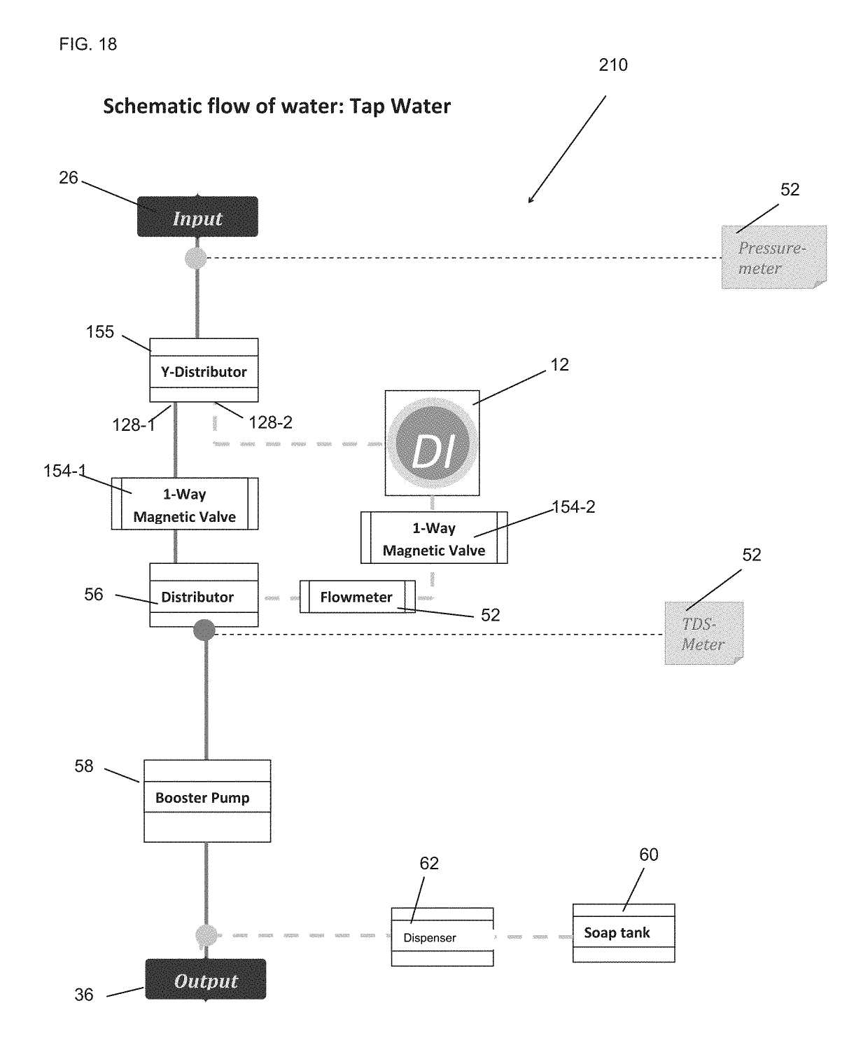

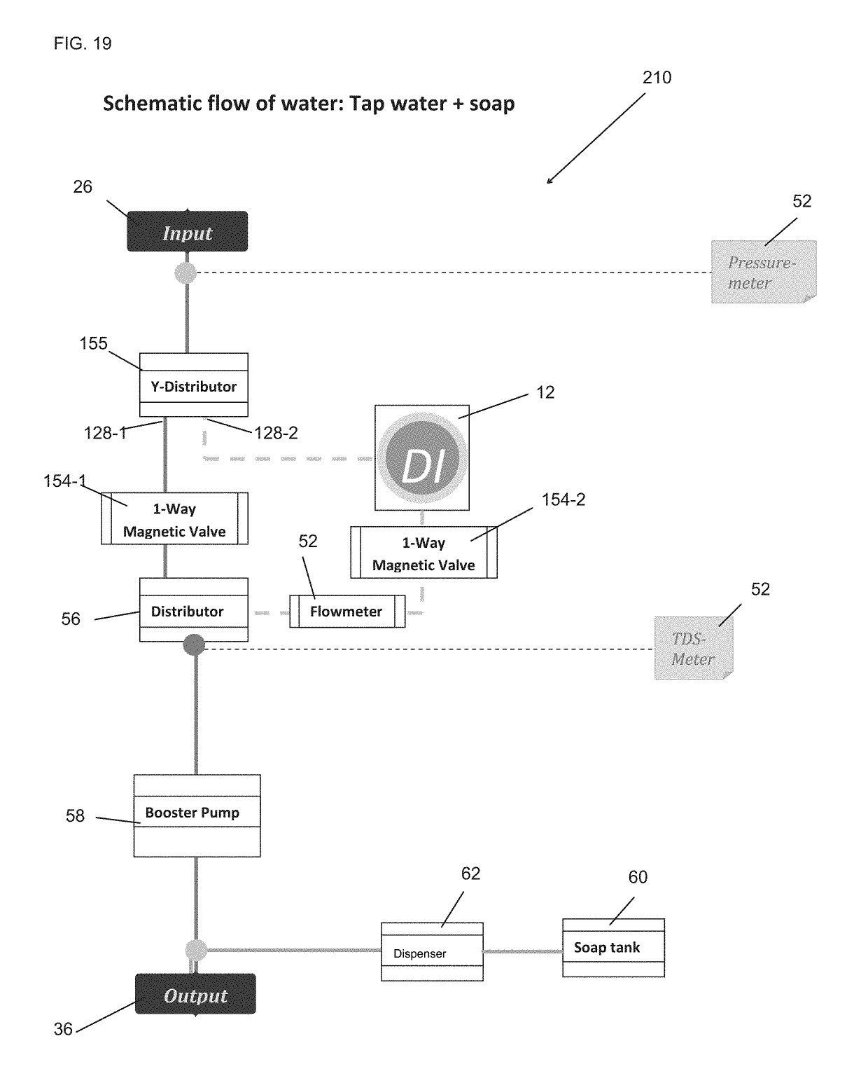

Of course, system 210 can be controlled to have first valve 154-1 closed and first valve 154-2 open, which diverts the incoming water to pass through outlet 128-1 of distributor 155 and bypass water conditioner 12 and, thus, provide tap water to the outlet 36 as is shown in FIGS. 18 and 19.

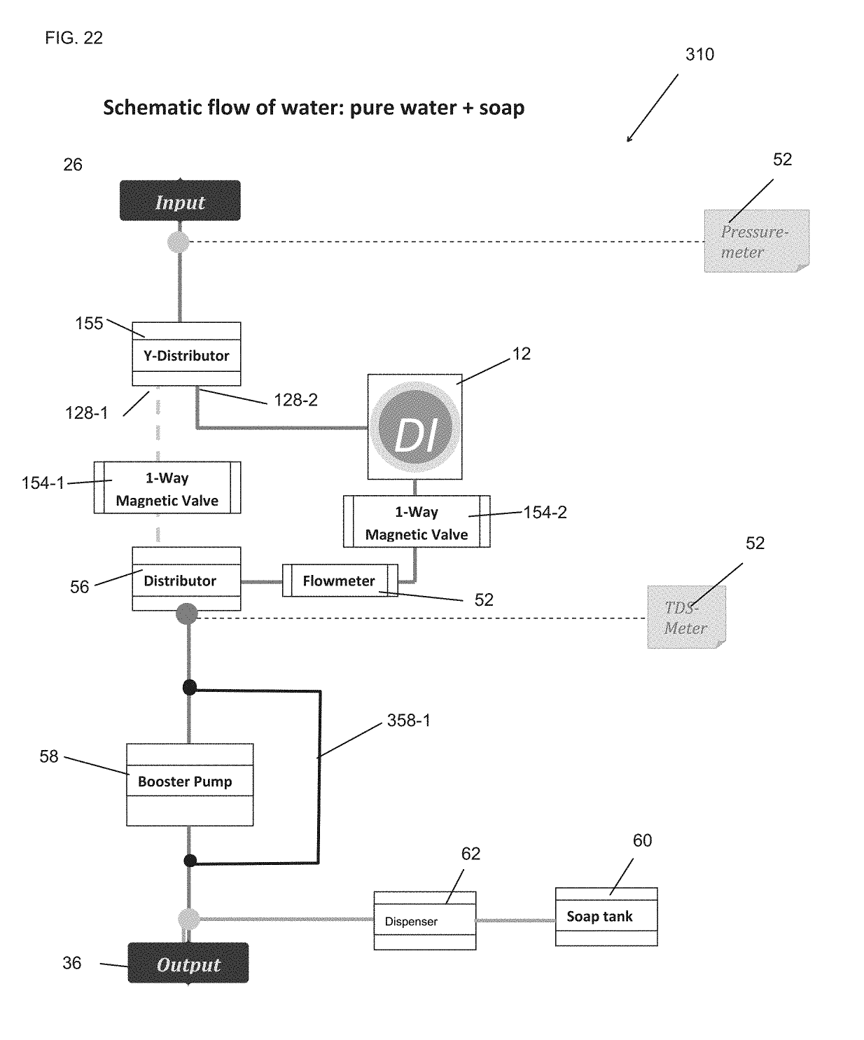

FIG. 22 illustrates another alternate exemplary embodiment of system 310 according to the present disclosure. In this embodiment, the flow path further includes a bypass 358 around booster pump 58. In this manner, water flowing through system 310 can divert around pump 58 when the pump is in its off or unused state.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of any claims.

LIST OF REFERENCE NUMERALS

| | |
|---|---|
| water cleaning system 10 | power source 42 |
| water conditioner 12 | power cord outlet 44 |
| water-fed cleaning brush 14 | control panel 46 |
| tubes 16 | remote or wireless controller 48 |
| extension pole 18 | antenna 50 |
| desired surface 20 | sensors 52 |
| control cabinet 22 | first valve 54 |
| movable cart 24 | distribution manifold 56 |
| tap water inlet 26 | water pressure booster pump 58 |
| first outlet 28 | cleaning agent reservoir 60 |
| inlet 30 of conditioner 12 | cleaning agent dispenser 62 |
| conditioned water inlet 32 | second valve 64 |
| outlet 34 of conditioner 12 | first outlet 36-1 |
| cleaning water outlet 36 | second outlet 36-2 |
| controller 40 | |

What is claimed is:

1. A water cleaning system comprising:
a water conditioner;
a first flow path valve for incoming water;
a cleaning agent reservoir;
a cleaning agent dispenser; and
a controller controlling the first flow path valve and the cleaning agent dispenser to operate among a plurality of cleaning modes, the plurality of cleaning modes being selected from the group consisting of a tap water mode, a conditioned water mode, a combined tap water and cleaning agent dispensing mode, and a combined conditioned water and cleaning agent dispensing mode,
wherein, when in the tap water mode, the controller controls the first flow path valve so that a flow of incoming water bypasses the water conditioner,
wherein, when in the conditioned water mode, controller controls the first flow path valve so that the flow of incoming water passes through the water conditioner,
wherein, when in the tap water and cleaning agent dispensing mode, the controller controls the first flow path valve so that the flow of incoming water bypasses the water conditioner and the controller controls the cleaning agent dispenser to supply cleaning agent from the reservoir to the water, and
wherein, when in the combined conditioned water and cleaning agent dispensing mode, the controller controls the first flow path valve so that the flow of incoming water passes through the water conditioner and the controller controls the cleaning agent dispenser to supply cleaning agent to the conditioned water.

2. The system of claim 1, further comprising a water pump, the controller being configured to operate the water pump, wherein the plurality of cleaning modes further comprises a pump assisted dispensing mode, and wherein, when in the pump assisted dispensing mode, the controller controls the water pump to apply a pressure to an outlet flow of water.

3. The system of claim 1, wherein the water conditioner comprises a plurality of water conditioners that are fluidly connected to one another in series, in parallel, and any combinations thereof.

4. The system of claim 1, wherein the plurality of water conditioners are all of a common type of conditioner, all of a different type of conditioner, and any combinations thereof.

5. The system of claim 1, wherein the water conditioner is selected from the group consisting of a filter, a deionizer, a demineralizer, a softener, an additive or component adding conditioner, and any combinations thereof.

6. The system of claim 1, wherein the water conditioner is selected from the group consisting of a particle filter, a chlorine filter, an ion remover, a UV sterilizer, and any combinations thereof.

7. The system of claim 2, wherein the water conditioner, the first flow path valve, the water pump, the cleaning agent reservoir, the cleaning agent dispenser, and the controller are secured on a movable cart.

8. The system of claim 2, wherein the controller, the water pump, and the cleaning agent dispenser are in communication with a power source.

9. The system of claim 8, wherein the power source is at least one of a battery, a power cord outlet, a fuel cell, a solar panel, a gas generator, and any combinations thereof.

10. The system of claim 9, wherein the water conditioner, the first flow path valve, the water pump, the cleaning agent reservoir, the cleaning agent dispenser, the controller, and the power source are secured on a movable cart.

11. The system of claim 1, further comprising a control panel in communication with the controller.

12. The system of claim 11, further comprising a wireless controller in communication with the controller.

13. The system of claim 12, wherein the wireless controller comprises a control fob, a software application loaded onto a user device, and combinations thereof.

14. The system of claim 1, further comprising a pressure meter and a total dissolved solids meter in communication with the controller, wherein the total dissolved solids meter being in fluid communication with an outlet and/or an inlet of the water conditioner.

15. The system of claim 1, further comprising a GPS location signal in communication with the controller, the GPS location signal being generated at the controller or received by the controller from a GPS enabled user device.

16. The system of claim 2, further comprising a distribution manifold in fluid communication with the first flow path valve and an outlet of the water conditioner, the first flow path valve being controlled by the controller to selectively place the distribution manifold in fluid communication with the flow of incoming water or the outlet flow of water.

17. The system of claim 16, wherein the water pump is in fluid communication with an outlet of the manifold.

18. The system of claim 16, wherein the cleaning agent reservoir is in fluid communication with the manifold.

19. The system of claim 18, wherein the cleaning agent dispenser is a pump or a valve.

20. The system of claim 16, wherein the manifold has an outlet in fluid communication with a second flow path valve, the second flow path valve being in communication with the controller and fluid communication with at least two outlets so that the second flow path valve controls an outgoing water direction.

21. The system of claim 1, wherein the controller is in electrical communication with a plurality of sensors to collect information regarding one or more attributes selected from the group consisting of a GPS location of the system, an elapsed time that the system was used at a particular location, a number of gallons of tap water used, a number of gallons of conditioned water used, an amount of cleaning agent used, a pressure at any point in the system, a flow rate at any point in the system, a containment level, a chlorine level, a salt level, a quality of water currently provided by the conditioner, a TDS level, a quality of tap water entering the system, and any combinations thereof.

22. The system of claim 21, wherein the controller is configured to store and/or communicate the information regarding the one or more attributes.
